(19) United States
(12) Patent Application Publication
(10) Pub. No.: US 2004/0082218 A1
(43) Pub. Date: Apr. 29, 2004

(54) Coaxial cable F-connector assembly with sealing ring

(75) Inventor: Albert Stirling, Markham (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Cabletel Communications Corp., Markham (CA)

(21) Appl. No.: 10/277,888

(22) Filed: Oct. 23, 2002

(51) Int. Cl. H01R 9/05

(52) U.S. Cl. 439/587

(57) ABSTRACT

An F-connector assembly for installing a flexible coaxial cable to an electrical device. A sealing ring is disposed around the body of the F-port, positioned so as to create a seal with a mating coaxial cable connector plug when the plug is attached to the F-port.

### FIELD OF THE INVENTION

This invention relates generally to connecting devices for coaxial cable, such as the type used for cable and satellite TV transmission. In particular, the invention relates to F-connectors which are commonly used to connect flexible coaxial cable in cable and satellite TV signal distribution systems.

### BACKGROUND OF THE INVENTION

Flexible coaxial cable is used extensively in cable and satellite television distribution systems. Such cable consists of a central conducting wire, a dialectic insulator encasing the central conductor, at least one aluminum tape shield and one braided shield around the dialectic insulator, and a jacket covering the braided shield. Common 75 ohm flexible coaxial cable, such as RG-59 type, is typically used for drop lines from tap devices on trunk line feeders to customers' homes.

Such coaxial cables are usually connected by Type F connectors. F-connectors come in different configurations but most commonly consist of a male plug that is mounted to the coaxial cable, and a female jack or socket which is assembled to a tap or other electrical device, such as a ground block or a cable splice coupling unit. The female jack is commonly referred to as an F-port.

The F-port includes an internal clip pin or other electrical contact mechanism that receives the central conductor of the coaxial cable extending from the male plug. The internal contact mechanism is insulated from the body of the F-port and provides an electrical connection from the central conductor of the coaxial cable to the circuit within the electrical device.

The F-port may be assembled to a tap or other electrical device by a press fit, or a threaded connection, or by other assembly means. The male plug, which is mounted to the cable, is removably attached to the F-port by means of an internally threaded rotatable nut which engages outer threads on the outer end of the F-port.

Taps, including multi-port taps, and other devices that include F-ports, such as ground blocks and cable splicing couplers, are often used in outdoor locations, exposed to moisture. In such environments, there is a risk that, moisture can penetrate between the F-port and the male plug leading to potential signal loss and deterioration of the circuitry.

Various means have been proposed to combat such moisture penetration. In some cases, for example, an outer jacket or boot is mounted on the F-port and then pulled back to cover a portion of both the F-port and the male plug after the cable has been installed. Other means include paint on sealants and heat activated shrink sealing tape.

All of these known means for preventing moisture penetration between the mating components of an F-connector suffer from the disadvantage of being awkward and time consuming to apply, particularly in field installations and in inclement weather. Moreover, in the case of some of the known moisture barriers, subsequent removal of the cable permanently destroys the seal.

The object of the present invention is to obviate or mitigate these and other disadvantage of known F-connectors, and particularly to provide an F-connector that better resists moisture penetration and is easier to use.

### BRIEF SUMMARY OF THE INVENTION

In accordance with the present invention, an F-connector assembly is provided for installing a flexible coaxial cable to an electrical device. The connector comprises a generally cylindrical F-port body, with an electrical contact mechanism therein, and a sealing ring disposed around the body.

The body has an outer portion with a threaded end for receiving a mating coaxial cable connector plug, and an inner portion configured for assembly to the electrical device. The internal contact mechanism is insulated from the body of the F-port and includes a clip pin or other means for receiving the central conductor of a connected coaxial cable. The electrical contact mechanism provides an electrical connection from the cable to the circuit within the electrical device.

The sealing ring is disposed around the outer portion of the body of the F-port, positioned so as to create a seal with a mating coaxial cable connector plug when the plug is attached to the F-port.

Preferably, the sealing ring is in the form of an O-ring that is retained in a recess adjacent the threaded end of the outer portion of the F-port body. Advantageously, the O-ring has an internal diameter of 0.300 inches and a cross-sectional diameter of 0.045 inches.

Most preferably, the F-connector assembly also includes a coaxial cable plug mounted or mountable to a coaxial cable, having a rotatable nut with internal threads that mate the threaded end of the F-port body for joining the connector plug to the F-port. Advantageously, the nut of the connector plug has a non-threaded rim extending forwardly from its inner threads to engage and seal to the sealing ring when the connector plug is joined to the F-port.

In accordance with another aspect of the present invention, there is provided a method of installing a flexible coaxial cable to an electrical device by means of F-connector, which comprises the following steps:

providing an electrical device with an F-port assembled thereto, the F-port having a generally cylindrical body with an outer threaded end, and an insulated internal electrical contact mechanism for receiving the central conductor of an attached coaxial cable and providing electrical connection to the circuit within the electrical device, and having an O-ring disposed around the F-port body adjacent its threaded end;

joining the coaxial cable to the F-port by attaching a mating connector plug mounted to the cable, the plug having a rotating nut which is fastenable to the threaded end of the F-port body; and

tightening the nut of the connector plug so that it contacts and seals to the O-ring of the F-port.

It has been found that the F-connector assembly and installation method of the present invention provides an effective and economical solution to the problems presented by known prior art F-connectors, as described above. Because the F-port includes the sealing ring as an integral part, installation of the coaxial cable requires no additional components, tools, or manipulation to realize a moisture barrier. Simply attaching the cable connector plug by means of its threaded nut engages the sealing ring to create an effective seal between the F-port and the cable connector plug.

### BRIEF DESCRIPTION OF THE DRAWINGS

In order that the invention may be more clearly understood reference will be made to the accompanying drawings which illustrate a preferred embodiment of the F-connector of the present invention, and in which:

FIG. 1 is a cross-sectional side view of an F-connector assembly according to one embodiment of the present invention, comprising an F-port and an unattached connector plug mounted to a coaxial cable;

FIG. 2 is a cross-sectional side view of the fully attached connector assembly of FIG. 1;

FIG. 3 is a perspective view of a multi-port tap device with coaxial cables connected thereto by means of F-connector assemblies according to the same embodiment of the present invention.

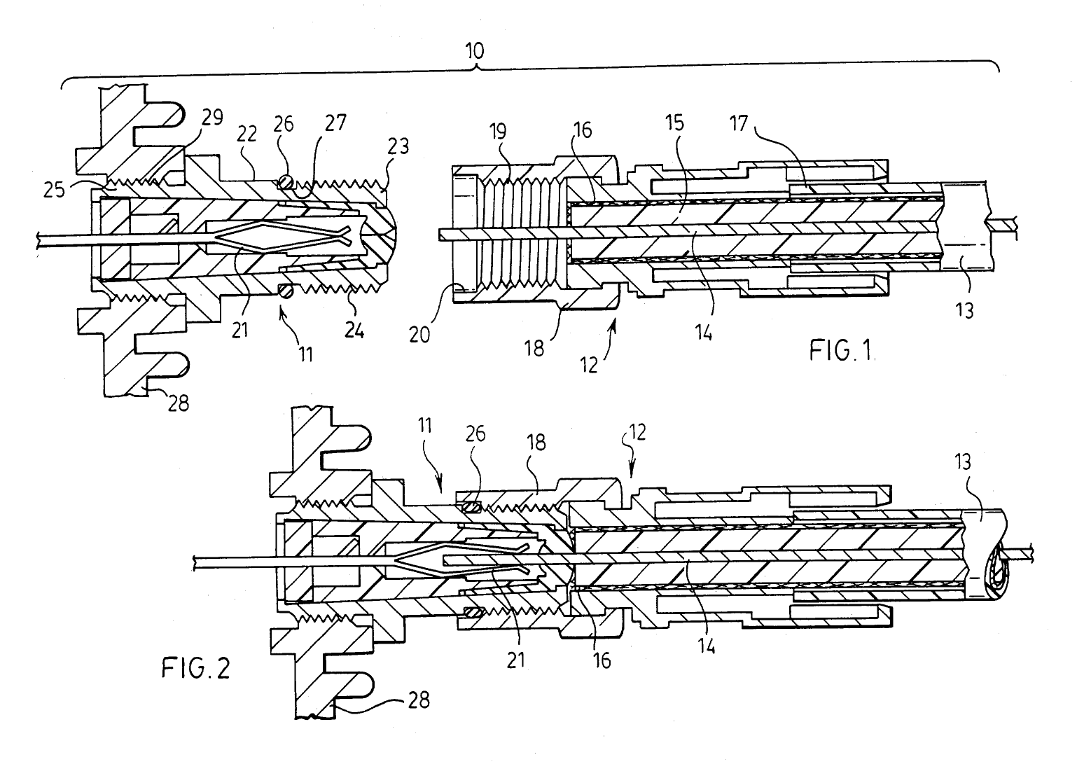

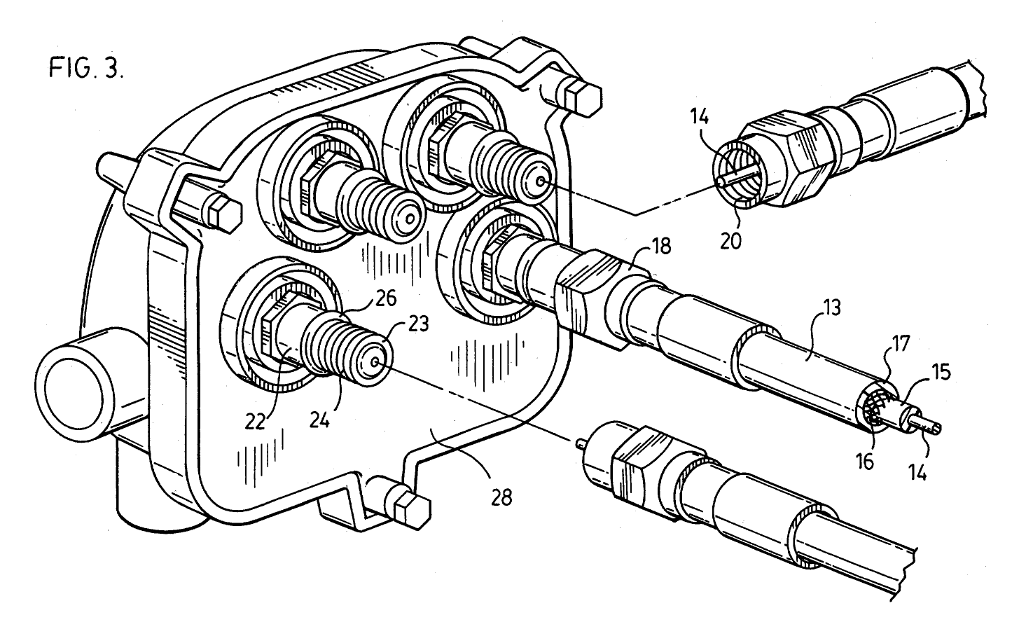

### DESCRIPTION OF THE PREFERRED EMBODIMENT

As shown in the drawings, the F-connector assembly 10 includes an F-port (or jack or socket) 11 and a plug (or male connector) 12. The F-port is assembled or assembleable to a multi-tap distribution device 28.

The plug 12 is shown mounted to a coaxial cable 13 which has a central conductor 14, a dielectric insulator 15 encasing the central conductor, a braided shield 16 around the dielectric insulator, and a jacket 17 covering the braided shield 16. The F-connector 10 of the present invention is intended for use with common 75 ohm flexible coaxial cable, such as RG-59 and RG-6 type cables and also RG-7 and RG-11 type cables. These are the types of coaxial cable typically used as drop lines from outdoor multiport tap devices to connect feeders from main trunk lines to customers' homes.

The plug 12 mounts to the coaxial cable 13 so as to form a moisture-resistant seal, as taught for example by the inventor's U.S. Pat. No. 6,261,126. The plug 12 has a brass body and includes a rotatable nut 18, also brass, with internal threads 19 by means of which the plug 12 may be fastened to the F-port 11. The plug 12 mounts to the coaxial cable 13 with a portion of the central conductor 14 extending forwardly of the rotatable nut 18 for engagement within the F-port 11.

The F-port 11 has a generally cylindrical brass body having an upper portion 22 to which the male connector plug 12 may be attached, and a lower portion 25 configured for assembly to an electrical device, such as a multi-tap 28, by threads 29. The upper portion has a threaded end 23 with standard UNF threads 24 that mate with the threads 19 of the rotatable nut 18 on the cable plug 12. A rubber O-ring 26 is disposed around the upper portion 22 of the body 21 of the F-port 11, retained in a groove 27 adjacent the threaded end 23.

The O-ring 26 has an internal diameter of 0.300 inches and a cross-sectional diameter of 0.045 inches. The diameter of the upper portion 22 of the F-port body 21 is 0.384 inches, and the diameter of the groove 27 is 0.3175 inches. The inner diameter of the non-threaded rim 20 of the rotatable nut 18 of the plug 12 is 0.388 inches, and the outer diameter of the rotatable nut 18 is 0.433 inches.

Within the body of the F-port 11 is a clip pin contact mechanism 21 insulated from the body 12. When the plug 12 is joined to the F-port 11, the contact mechanism 21 receives the central conductor 14 of the coaxial cable 13 and provides electrical connection to the circuit within the electrical device to which the F-port 11 is assembled.

As shown most clearly in FIG. 2, when the plug 12 is fully attached to the F-port 11 to install the coaxial cable 13 to an electrical device such as the multi-tap 28, the rotatable nut 18 of the plug 12 is screwed onto the threaded end 23 of the F-port 11. The non-threaded rim 20 of the rotatable nut 18 is brought into contact with the O-ring 26 and forms a moisture resistant seal therewith as the rotatable nut 18 of the plug 12 is fully tightened onto the upper portion 22 of the F-port 11.

No additional steps are required in installing a coaxial cable to an electrical device to realize a moisture resistant seal between the cable plug and the F-port. No additional components need be applied or manipulated, and no special tools are required.

It will of course be appreciated that many variations are possible within the broad scope of the present invention. For example, while in the preferred embodiment described above the F-port is assembled to the electrical device by a threaded engagement, it may alternatively be assembled by solid casting or a press fit.

A sealing ring other than an O-ring can be substituted. The configuration and placement of the sealing ring must though be contacted by the rim of the rotatable nut and form a seal therewith as the plug is fully attached to the F-port. The dimensions of the F-port body, the O-ring, and the retaining groove may also be modified while still providing an effective seal as will be apparent to those skill in the art.

Furthermore, while both the plug and jack of the F-connector described above are made of brass, other materials could be substituted, provided they have the desired properties of strength, conductivity, surface hardness and corrosion resistance.

I claim:

1. An F-connector assembly for installing a flexible coaxial cable to an electrical device, comprising:
a generally cylindrical F-port body having an outer portion with a threaded end configured for joining to a mating coaxial cable plug, and an inner portion configured for assembly to an electrical device;
an electrical contact mechanism within said F-port body insulated therefrom, for receiving the centre conductor of an attached coaxial cable and providing electrical connection therewith to the circuitry of the electrical device; and
a sealing ring disposed around said outer portion of said F-port body, for sealing to a mating coaxial cable plug joined to said threaded end of said F-port body.

2. The F-port connector assembly of claim 1, wherein the sealing ring is retained in a recess adjacent said threaded end of said outer portion of said F-port body.

3. The F-port connector assembly of claim 2, wherein the sealing ring has an internal diameter of approximately 0.300 inches and a cross-sectional diameter of approximately 0.045 inches.

4. The F-connector assembly of claims 1, 2 or 3, further comprising a coaxial cable plug mounted or mountable to a coaxial cable, having a rotatable nut with internal threads mating with the threaded end of said F-port body for joining said plug to said F-port, said nut having a non-threaded rim extending outwardly of the inner threads thereof, that engages and seals to said sealing ring when said plug is joined to said F-port.

5. The F-port connector assembly of claim 4, wherein said non-threaded rim has an internal diameter of approximately 0.388 inches.

6. A method of installing a flexible coaxial cable to an electrical device by means of an F-connector comprising the steps of:
providing an electrical device with an F-port assembled thereto, said F-port having a generally cylindrical body with an outer threaded end, and an insulated internal electrical contact mechanism for receiving the central conductor of an attached coaxial cable and providing electrical connection to the circuit within said electrical device, and having an O-ring disposed around said F-port body adjacent said threaded end;
attaching said coaxial cable to said F-port by means of a mating connector plug mounted to said cable, said plug having a rotating nut which is fastenable to said threaded end of said F-port body; and
tightening said nut of said connector plug so that it contacts and seals to said O-ring of said F-port.
